(19) United States
(12) Patent Application Publication
(10) Pub. No.: US 2019/0360266 A1
(43) Pub. Date: Nov. 28, 2019

(54) Gate With An Emergency Opening Device

(71) Applicant: Gabrijel Rejc GmbH & Co. KG, Landshut (DE)

(72) Inventor: Gabrijel Rejc, Landshut (DE)

(21) Appl. No.: 16/470,139

(22) PCT Filed: Nov. 15, 2017
(86) PCT No.: PCT/EP2017/079330

§ 371 Date: Jun. 14, 2019

(30) Foreign Application Priority Data
Dec. 15, 2016 (DE) 10 2016 225 078.7

(51) Int. Cl. E06B 9/68; E06B 9/82; E05F 15/72

(52) U.S. Cl. CPC E06B 9/68; E06B 9/82; E05Y 2900/146; E06B 2009/6809; E05F 15/72

(57) ABSTRACT

The present invention relates to a gate with an emergency opening device, comprising a gate panel which is movable between an open and a closed position, a primary motor which drives the gate panel by way of a gate panel drive, and an auxiliary motor which is connected to an emergency power supply and is adapted to drive the gate panel. In order to improve such a gate to the extent that the emergency opening device is reliably usable to open the gate in the event of different types of failure of the main drive motor of the gate, it is proposed that the auxiliary motor be coupled by way of an auxiliary motor coupling to the gate panel and that the emergency power supply comprise an energy storage.

The present invention relates to a gate with an emergency opening device having the features of the preamble of claim 1.

Such gates are suitable, inter alia, for industrial applications, for locking production facilities, workshops and warehouses. For example, they are designed to reduce air movement and help maintain temperatures in cooled or heated areas. Typical embodiments are sectional gates, rolling gates and spiral gates. Such gates can have gate leaves separated into sections that are movable relative to each other and which are guided laterally in the gate frames and opened or closed with a vertical movement.

In particular vertically movable gate can be embodied with or without a weight counterbalancing mechanism. Known weight counterbalancing mechanisms include springs that are tensioned when the gate is closed and relax when the gate is opened, where the energy stored in the spring assists in opening the gate, thus allowing the gate to be moved with less effort. Gates with no weight counterbalancing mechanism reduce production effort and susceptibility to wear.

To ensure operational safety, such electrically driven gates should be openable also in the event of failure of the motor, for example, during a power outage. People who are in a room closed by the gate at the time of the motor failure must be able to open the gate to free themselves. Otherwise, there would be danger to the health and life of the respective people, for example, if they are in an enclosed refrigeration room.

Known gates provide ways to manually open the gate, for example, by manually pushing the gate upwards. Such a solution is particularly suitable for gates with a weight counterbalancing mechanism, when the weight counterbalancing mechanism keeps the force required to open the gate low and the gate can be moved by one person without any aids. Alternative manual solutions use manual winches or manual chains.

DE 29 35 490 A1 proposes a generic gate with an AC positioning regulating drive for driving a gate. An electric motor drives a belt pulley by way of a worm gearing, where the belt drives the gate. The worm gearing engages a measuring gear, by use of which the position of the gate is determined in order to control the motor and the speed of movement of the gate in the different phases of movement based on this measurement. Installed downstream on the common shaft of the main motor are two additional auxiliary motors which in the event of failure of the main power supply are driven by an emergency power supply to operate the gate during power outage. The main motor as well as the two auxiliary motors and the worm gearing are embodied in a common housing. The position measurement can be effected with the worm gearing also when the auxiliary motors are operated, since the auxiliary motors drive the shaft of the main motor. The safety function of the drive described is explicitly geared toward the interruption of the main power supply. However, types of failure other than just a power outage could occur with these configurations.

EP 2 8 87535 A1 discloses a drive and control system for gates which enables emergency opening of the gate during a power outage. In this case, a drive motor, which is in particular a synchronous motor, is employed to brake the gate and can be regulated down to zero rotational speed. The motor is connected to a rechargeable battery unit which maintains this motor controller operational even in the event of a failure of the external power supply and is also suitable to drive the motor during the emergency opening of the gate. The rechargeable battery unit during normal operation of the gate is geared toward being charged by the electric motor which can recuperate energy released when the gate is closed.

The present invention is based on the object of improving a gate with an emergency opening device to the extent that the emergency opening device can be reliably used to open the gate in the event of different types of failure of the main drive motor of the gate.

The object is satisfied according to the invention with a gate with an emergency opening device having the features of claim 1.

By coupling the auxiliary motor to the gate panel by way of its own auxiliary motor coupling, the emergency opening is less dependent on the coupling of the primary motor to the gate panel drive. As a result, the safety and reliability of the emergency opening device can be increased. Opening the gate during power outages is made possible by this arrangement, but also, for example, in the event of material failure in the primary motor, which leads to it being blocked, or in the energy transfer between the primary motor and the gate panel drive.

The use of an energy storage for the emergency power supply makes the emergency opening device less dependent on external power supply, so that it can remain operable even in the event of a complete power outage.

For the purposes of the present invention, the auxiliary motor coupling should be suitable for transmitting power from the auxiliary motor to the gate panel. The term “coupling” does not necessarily mean that the auxiliary motor coupling is releasable and lockable.

The primary motor is designed to open and close the gate at the speeds desired during normal operation and demands sufficiently high electrical power to ensure these speeds. The auxiliary motor can be configured, for example, to be operated with significantly less electrical power, since it depends less on the speed of movement of the gate during emergency operation, but primarily on the gate to move at all. The energy storage can therefore advantageously be configured having a relatively low capacity in order to reduce its cost.

According to one embodiment variant, the auxiliary motor can be coupled and decoupled by way of the auxiliary motor coupling to the gate panel drive. In particular, during normal operation of the gate with the primary motor, the auxiliary motor can be decoupled from the gate panel drive by releasing the auxiliary motor coupling. The components in the auxiliary motor can therefore remain unmoved during normal operation of the gate. Firstly, the wear in the auxiliary motor can be reduced and, secondly, the reduction of the moving parts reduces the inertia in the system.

In one further development, the primary motor can be decouplable from the gate panel drive by way of a primary motor coupling. In particular, in the event of an emergency opening of the gate using the auxiliary motor, the primary motor can be decoupled from the gate panel drive by releasing the primary motor coupling. During an emergency opening, the primary motor can remain motionless. The emergency opening can then still be performed, in particular, when the primary motor is blocked. In addition, the inertia of the system is reduced because the moving parts of the primary motor are not moved during the emergency opening.

In one variant, a braking device can be provided which is adapted to hold the gate panel automatically in a position and to be released when powered by the emergency power supply. The braking device can hold the gate automatically, i.e. even without external power supply, in one position and thus reliably prevent the gate from crashing down, especially in the event of a power outage. In order to use this characteristic of the brake and still be able to perform the emergency opening of the gate in the event of a power outage, the automatic brake can be powered by the emergency power supply to be able to release it and open the gate without external power supply.

According to one embodiment of the invention, an emergency controller suitable for detecting a failure of the primary motor and for activating the braking device is provided. As a result, a crash down of the gate panel can be reliably and quickly prevented after the occurrence of a failure in the drive of the gate.

The emergency controller can possibly be suitable to decouple the primary motor from the gate panel drive in the event of a failure of the primary motor. Decoupling the primary motor from the gate panel is simple and reliably feasible by way of the emergency controller.

In one advantageous embodiment, the emergency controller can be adapted to couple the auxiliary motor to the gate panel drive in the event of failure of the primary motor. The power transmission of the connection between the auxiliary motor and the gate panel drive can then be advantageously established in preparation for the emergency opening of the gate.

The emergency controller can advantageously be arranged to fulfill some of the aforementioned tasks in an automated manner or by external control. For example, in the event the primary motor is decoupled from the gate panel drive, the auxiliary motor can automatically be coupled to the gate panel drive in order to subsequently start a manually initiated emergency opening. It would also be advantageous to have the emergency controller be able to detect a power outage by itself and then automatically trigger the decoupling/coupling operations.

The object of the invention mentioned above is also satisfied with a method having the features of claim 9.

By coupling the auxiliary motor to the gate panel drive by way of its own auxiliary motor coupling, the emergency opening of the gate by way of the auxiliary motor can be performed reliably and even in the event of different types of failure of the main motor. For example, in the event of power outages or material failure in the primary motor, the emergency opening of the gate can be performed by the auxiliary motor.

The auxiliary motor can advantageously initially be decoupled from the gate panel drive and coupled by way of the auxiliary motor coupling to the gate panel drive. During normal operation of the gate, the auxiliary motor can be decoupled from the gate panel drive, so that it does not necessarily move along when the gate panel is opened or closed by the primary motor. As a result, the wear in the auxiliary motor can be reduced and the inertia of the system during normal operation can be reduced. If an emergency opening is to be carried out, then the auxiliary motor is coupled to the gate panel drive by way of the auxiliary motor coupling in order for the gate to be opened using the auxiliary motor.

It is conceivable that the primary motor can initially be coupled to the gate panel drive and be decoupled from the gate panel by way of a primary motor coupling. During normal operation of the gate, the primary motor is coupled to the gate panel drive in order to be able to move it up and down. For the emergency opening of the gate, the primary motor is decoupled from the gate panel drive, so that the emergency opening can be carried out with the primary motor being at a standstill. By decoupling the primary motor, firstly, the inertia of the system can be reduced in order to reduce the power necessary for the emergency opening. Secondly, the emergency opening of the gate can be ensured during normal operation even with a blocked primary motor, or a blocked connection of the primary motor to the gate panel drive.

Coupling the auxiliary motor to the gate panel drive and decoupling the primary motor from the gate panel drive can advantageously be linked, so that only one of the two motors is respectively coupled to the gate panel drive, and coupling one motor to the gate panel drive automatically leads to decoupling the other motor.

In one variant of the invention, a braking device can first be triggered in the event of failure of the primary motor and automatically hold the gate panel. This effectively prevents the gate from crashing down to increase safety for people and objects in the gate area.

According to one further embodiment, the braking device can be released in a manner powered from an energy storage. As a result, the movability of the gate can be released to perform the emergency opening thereof.

The invention shall be explained hereafter with reference to some embodiments, where:

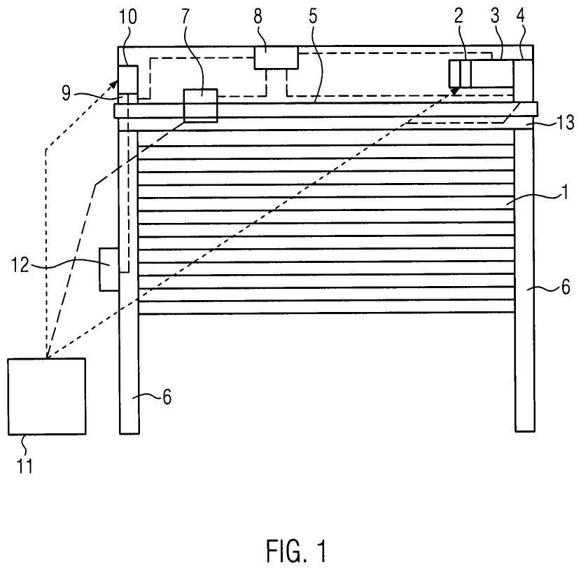

FIG. 1 shows a schematic diagram of a gate according to the invention,

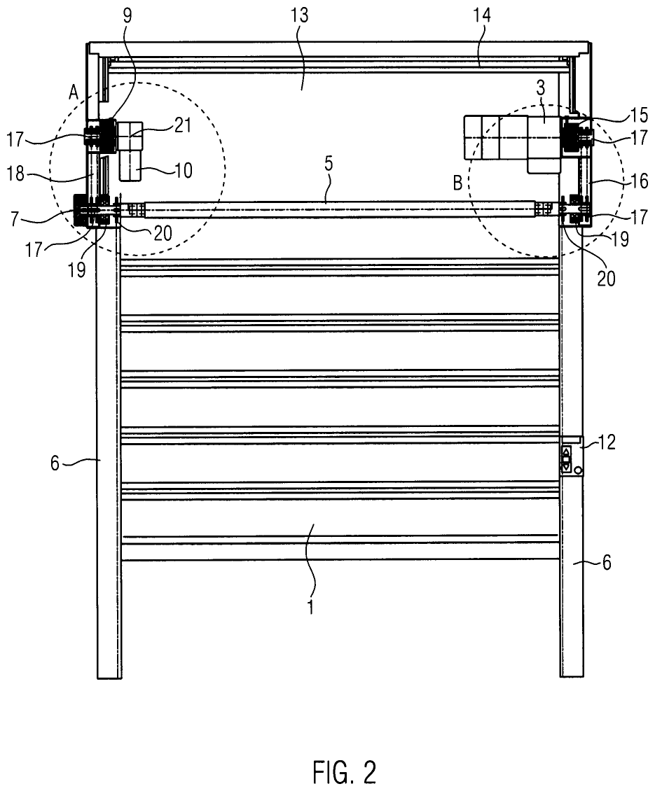

FIG. 2 shows a second embodiment in a sectional view,

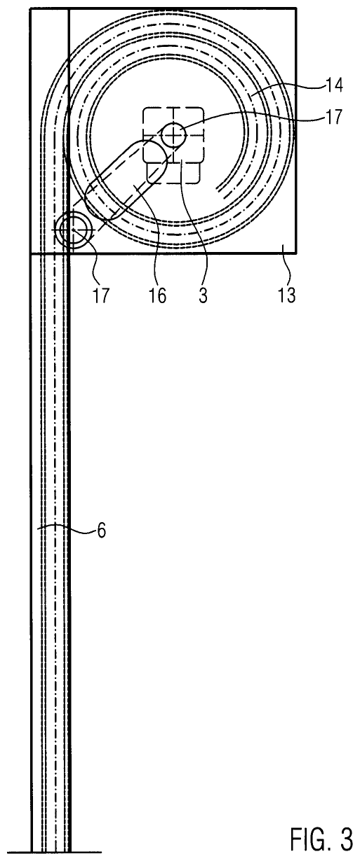

FIG. 3 shows the embodiment shown in FIG. 2 in a side view,

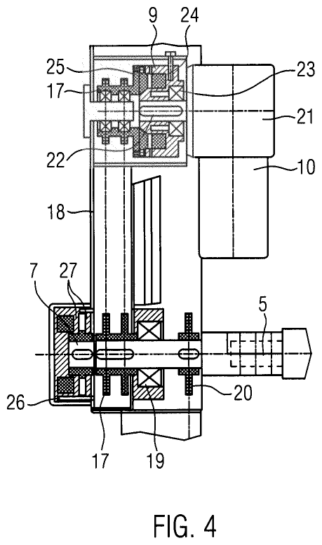

FIG. 4 shows the enlarged section marked as A in FIG. 3, and

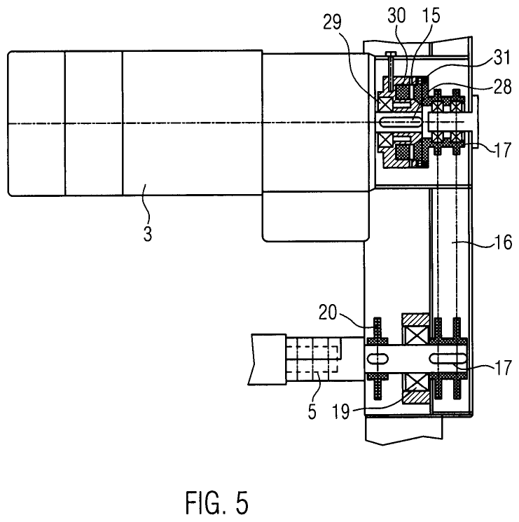

FIG. 5 shows the enlarged section marked as B in FIG. 2.

Same reference numerals are used for same or corresponding features in the different figures and with reference to different embodiments. An explanation of corresponding or same features regarding the subsequent figures is dispensed with if they have already been explained.

The following embodiments relate mainly to high-speed doors, i.e. doors whose door leaves reach vertical velocities of more than 1.5 m/s, 2 m/s and/or 4 m/s, and are in particular in the range of 2 to 4 m/s.

The gate shown in FIG. 1 is configured as a spiral gate, where gate panel 1 is constructed of a number of gate sections that are movable relative to each other and extend in the horizontal direction between two gate frames 6. The gate is shown open to about one third. Essential parts of the drive of the gate are provided in lintel 13 above the passage height and presently shown schematically. In the open state, the gate panel is stored in a spiral attached in lintel 13. Other configuration variants of the gate are possible according to the invention, for example, as a rolling gate which is wound on a winding shaft.

The gate shown also comprises no weight counterbalancing mechanism, which makes it relatively difficult to be opened manually in the event of failure of the motor. In alternative embodiments, weight counterbalancing mechanisms can be provided, for example, based on spring force.

A gate panel shaft 5 serves as a gate panel drive and extends horizontally approximately over the entire width of the gate. Not shown in the diagram, the gate comprises a pair of gear wheels which are embodied on both sides of the gate panel on the gate panel shaft. They engage drive chains which are connected on both sides at the gate panel in the region of the gate frames to the gate panel. With the rotation of gate panel shaft 5, the gear wheels mesh with the drive chains and thus convey gate panel 1 past gate panel shaft 5 into the spiral in the area of the gate lintel.

Gate panel shaft 5 is connected via a primary gearing 4, in which a switchable coupling is provided, to primary motor 3, so that during normal operation, the mechanical power of primary motor 3 is transmitted via primary gearing 4 to gate panel shaft 5 for opening or closing gate panel 1. Primary gearing 4 can be configured as a worm, spur or bevel gearing with chain or belt drives. Gearless versions are likewise conceivable in which a gate panel drive is connected directly to the primary motor shaft.

An auxiliary motor 10 is provided functionally and spatially separated from primary motor 3 and can be coupled and decoupled by way of an auxiliary motor coupling 9 to gate panel shaft 5. Primary motor 3 can be configured as a synchronous or asynchronous motor and driven, for example, with three-phase or alternating current. In advantageous embodiments, the auxiliary motor is configured having significantly less power than the primary motor. Since its task is to carry out an emergency opening of the gate, the speed of movement of the gate panel that can be achieved by way of the motor is of secondary importance.

In the example shown, the auxiliary motor is designed as a DC motor to be advantageously supplied from the energy storage intended as a DC power source.

A braking device 7 embodied as a spring-applied disk brake engages gate panel shaft 5 in the region of gate frame 12. In the embodiment, a brake disk is embodied in a rotationally fixed manner on the gate panel shaft. Two brake shoes 27 with brake pads mounted on both sides of the brake disk are pretensioned by spring force in the direction of the brake disk and kept spaced from the brake disk against the spring force by way of an electromagnet. To trigger catch brake 7, the electromagnets are deactivated so that the brake shoes are pressed by the spring force against the brake disk and brake the gate panel shaft. This arrangement has the further advantage that it is automatically activated and the brake is triggered in the event of a power outage. Primary motor 3, primary gearing 4 with the coupling, braking device 7 and auxiliary motor coupling 9 are connected to an emergency controller 8. Emergency controller 8 is able to detect a failure of primary motor 3 by way of the connection with primary motor 3, for example, due to a power outage or a technical failure of primary motor 3.

A manual control unit 12 is mounted at a location that can be reached from the exterior by an operator, for example, on a gate frame 6. Auxiliary motor 10 can be controlled by way of this control unit 12 to perform the emergency opening of the gate. Control unit 12 comprises a push-button with which a person can initiate the emergency opening of the gate. Pressing and holding the push-button initiates the emergency opening procedure during the power outage (etc.). The brake is bled and the gate panel is moved upwardly by the auxiliary drive. It must there be ensured that the brake re-engages when the push-button is released during the emergency opening.

In order to ensure the operation of the gate, in particular, the emergency opening and braking of the gate in the event of a complete power outage, braking device 7 and auxiliary motor 10 are connected to a rechargeable battery 11 which ensures the emergency power supply of the gate as the energy storage.

Rechargeable battery 11 is likewise connected to primary motor 3. The primary motor is capable of recovering energy released when closing or braking the gate, thereby charging the rechargeable battery.

One example of the structural design of a gate which can be equipped with an emergency opening device according to the invention is disclosed in EP 16 176 550.8. The gate described therein comprises a sectional gate panel which in the open state is stored in a spiral, where gear wheels engage drive chains embodied on both sides of the gate panel. The motor is coupled to a drive shaft of the gate panel by way of a belt.

During normal operation of the gate, gate panel shaft 5 is coupled via the coupling of primary gearing 4 to primary motor 5. A failure of primary motor 5, such as due to power outage or material failure in primary motor 5, is detected by emergency controller 8. In this case, the emergency controller 8 automatically triggers braking device 7, releases the coupling in primary gearing 4 and closes auxiliary motor coupling 9, so that the gate is in a state in which an emergency opening by way of auxiliary motor 10 can take place. The emergency opening is initiated manually by way of the control unit, if required.

FIG. 2 shows a second embodiment of a gate according to the invention in a partially opened state. When the gate is open, the gate panel is stored in a spiral 14 formed in lintel 13.

The controllers for the motors as well as emergency controller 8 and rechargeable battery 11 are embodied together with manual control unit 12 in a common housing in gate frame 6 on the right-hand side. In alternative embodiments, these elements can be embodied individually or together in the area of lintel 13.

Primary motor 3 is arranged inside gate spiral 14 and connected to a chain wheel 17 by way of a primary motor coupling 15. Said chain wheel 17 of the primary motor is connected via a primary chain 16 to a chain wheel 17 of gate panel shaft 5. Gate panel shaft 5 is supported on both sides by rolling bearings 19 in the region of gate frames 6. Embodied close to both ends of gate panel shaft 5 is a respective drive wheel which engages in a respective drive device in the gate panel and thus converts the rotation of the gate panel shaft to a vertical movement of the gate panel.

Arranged within spiral 14 on the left-hand side of the gate is auxiliary motor 10. In analogy to the connection of the primary motor, auxiliary motor 10 can be coupled by way of an auxiliary motor coupling 9 to a chain wheel 17 which drives a chain wheel 17 on gate panel shaft 5 by way of an auxiliary chain 18.

The gate shown in FIG. 2 is shown In FIG. 3 from the side. It can be clearly seen that primary motor 3 is embodied within spiral 14 which is presently shown in dashed lines. Primary chain 16 extends from chain wheel 17 of primary motor 3 to chain wheel 17 of the gate panel shaft laterally from spiral 14.

FIG. 4 shows enlarged auxiliary motor 10 as well as its coupling to gate panel shaft 5, as indicated in region A in FIG. 2. Auxiliary motor 10 is coupled via auxiliary motor gearing 21 to an intermediate shaft 22. A rolling bearing 23 is provided for mounting the intermediate shaft. Power transmission between the shaft of auxiliary motor 10 and intermediate shaft 22, which are aligned at approximately 90° relative to each other, is effected by way of a bevel gear. Alternatively, worm gearings or the like are conceivable.

Intermediate shaft 22 is connected by way of the switchable auxiliary motor coupling to a chain wheel 17 which transmits power via auxiliary motor chain 18 to chain wheel 17 on gate panel shaft 5. The power transmission in auxiliary motor coupling 9 is effected in a frictional manner between two coupling disks which are pressed against each other by spring force and are movable in an electrically operated manner.

Brake 7 is embodied as a spring-applied disk brake. In the embodiment, a brake disk 26 is embodied in a rotationally-fixed manner on the gate panel shaft. Two brake shoes 27 with brake pads mounted on both sides of the brake disk are pretensioned by spring force in the direction of brake disk 26 and kept spaced from the brake disk against the spring force by way of an electromagnet. To trigger catch brake 7, the electromagnets are deactivated so that brake shoes 27 are pressed by the spring force against the brake disk and brake gate panel shaft 5. This arrangement has the further advantage that it is automatically activated also in the event of a power outage and triggers the brake.

FIG. 5 shows in detail the part of the gate marked with reference symbol B in FIG. 2. Primary motor shaft 31 is mounted on a rolling bearing 30 and connected by way of a switchable primary motor coupling 15 to a chain wheel 17. Primary motor coupling 15 operates according to the same principle as the auxiliary motor coupling and comprises two coupling plates 30, 31 connected in a frictionally engaged manner which are pressed against each other by spring force.

1. A gate with an emergency opening device, comprising
a gate panel which is movable between an open and a closed position,
a primary motor which drives said gate panel by way of a gate panel drive, and
an auxiliary motor which is connected to an emergency power supply and adapted to drive said gate panel,
characterized in that said auxiliary motor is coupled by way of an auxiliary motor coupling to said gate panel, and
said emergency power supply comprises an energy storage.

2. The gate according to claim 1, characterized in that said auxiliary motor can be coupled and decoupled by way of said auxiliary motor coupling to said gate panel drive.

3. The gate according to claim 1, characterized in that said primary motor can be decoupled from said gate panel drive by way of a primary motor coupling.

4. The gate according to claim 1, characterized by a braking device which is adapted to hold said gate panel automatically in a position and to be released when powered by said emergency power supply.

5. The gate according to claim 4, characterized in that said braking device can be activated in the event of an interruption of a power supply to said braking device and can hold said gate panel in a position.

6. The gate according to claim 4, characterized by an emergency controller which is adapted to detect a failure of said primary motor and to activate said braking device.

7. The gate according to claim 5, characterized in that said emergency controller is adapted to decouple said primary motor from said gate panel drive in the event of failure of said primary motor.

8. The gate according to claim 7, characterized in that said emergency controller is adapted to couple said auxiliary motor to said gate panel drive in the event of failure of said primary motor.

9. A method for the emergency opening of a gate comprising a gate panel that is driven by a primary motor by way of a gate panel drive, is movable between an open and a closed position, and comprises an auxiliary motor connected to an emergency power supply,
characterized in that
power transmission from said auxiliary motor to said gate panel drive is effected by way of an auxiliary motor coupling.

10. The method according to claim 9, characterized in that said auxiliary motor is initially decoupled from said gate panel drive and is coupled by said auxiliary motor coupling to said gate panel drive.

11. The method according to claim 9, characterized in that said primary motor is initially coupled to said gate panel drive and decoupled from said gate panel drive by way of a primary motor coupling.

12. The method according to claim 9, characterized in that a braking device which automatically holds said gate panel is first triggered in the event of a failure of said primary motor.

13. The method according to claim 12, characterized in that said braking device is released when powered by said emergency power supply.

14. The gate according to claim 1, characterized in that said auxiliary motor is functionally and spatially separated from said primary motor.

15. The method according to claim 9, characterized in that said auxiliary motor is functionally and spatially separated from said primary motor.

16. The gate according to claim 5, characterized by an emergency controller which is adapted to detect a failure of said primary motor and to activate said braking device.

17. The method according to claim 10, characterized in that said primary motor is initially coupled to said gate panel drive and decoupled from said gate panel drive by way of a primary motor coupling.
